(19) United States
(12) Patent Application Publication
(10) Pub. No.: US 2005/0233854 A1
(43) Pub. Date: Oct. 20, 2005

(54) Variable speed compressor

(75) Inventors: Masaki Ota, Kariya-shi (JP); Masahiro Kawaguchi, Kariya-shi (JP); Akinobu Kanai, Kariya-shi (JP); Akihito Yamanouchi, Kariya-shi (JP); Shigeru Suzuki, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki, Kariya-shi (JP)

(21) Appl. No.: 11/108,956

(22) Filed: Apr. 19, 2005

(30) Foreign Application Priority Data
Apr. 20, 2004 (JP) 2004-124723

(51) Int. Cl. F16H 15/48

(52) U.S. Cl. 475/186

(57) ABSTRACT

A variable speed compressor has a housing, a compression mechanism and a variable speed mechanism including input and output shafts and a carrier each rotatable around a first axis, planetary cones received by the carrier and each rotatable around a respective second axis inclining to the first axis, and a control ring coaxial with the first axis to vary the speed of rotation of the planetary cones to move along the first axis. The rotating speed of the input shaft is controllably transmittable to the output shaft by transmitting torque thereof to the output shaft so that the input and output shafts and the control ring contact the planetary cones. The control ring having a cylindrical shape has first and second pressure sensing surfaces coaxial with the first axis, formed on the opposite side thereof, sensing pressure applied to the sensing surfaces for movement.

### BACKGROUND OF THE INVENTION

The present invention relates to a variable speed compressor having a variable speed mechanism.

One variable speed compressor is disclosed in Unexamined Japanese Patent Publication No. 11-22689. This variable speed compressor includes a housing, a compression mechanism contained in the housing for compressing refrigerant and a variable speed mechanism contained in the housing for changing the speed of rotation for driving the compression mechanism.

The variable speed mechanism includes an input shaft received rotatably around a first axis, an output shaft received rotatably around the first axis, a carrier provided rotatably around the first axis, at least three planetary cones received by the carrier and each rotatable around a respective second axis which inclines to the first axis, and an annular control ring coaxial with the first axis and operable to move in the direction parallel to the first axis for varying the speed of orbital motion of the planetary cones around the first axis. It is noted that the output shaft and the carrier are integrated as a holder in the compressor of the above Publication.

The compressor also includes a piston which is operable to reciprocate in the direction parallel to the first axis in a cylinder thereof. The piston is integrally formed with a piston rod to which the control ring is secured at a portion of the circumference thereof through a connecting fitting.

To the surface of the piston adjacent to the piston rod is applied discharge pressure or suction pressure in the compression mechanism, and on the opposite surface of the piston is provided a spring or urging means for urging in the direction that the piston rod protrudes from the cylinder. Each planetary cone has formed thereon a conical surface in frictional contact with the control ring.

This variable speed mechanism is operable to transmit the torque of the input shaft to the output shaft with varying the rotation speed of input shaft in such a way that the input shaft, the output shaft and the control ring cooperatively contact the planetary cones. To the output shaft is transmitted an angular velocity resulting from the orbital motion of the planetary cones.

In the variable speed compressor, when the piston rod of the piston protrudes to move the control ring to be in frictional contact with the smaller diameter portion of each conical surface of the planetary cone, each planetary cone rotates and orbits around the first axis at a lower orbital speed. Thus, the output shaft rotates at a lower speed. On the other hand, when the piston rod of the piston recedes to move the control ring to be in frictional contact with the larger diameter portion of each conical surface of the planetary cone, each planetary cone rotates and orbits around the first axis at a higher orbital speed. Thus, the output shaft rotates at a higher speed. Accordingly, in the variable speed compressor, the variable speed mechanism permits the compression mechanism to vary the driving speed thereof, so that the amount of refrigerant compression per unit time may be adjusted in the compression mechanism as may be necessary.

In the above conventional variable speed compressor, the control ring is pushed or pulled at a portion of the circumference thereof to move in the direction parallel to the first axis. Therefore, the control ring tends to incline relative to the first axis, with the result that it is hard for the variable speed mechanism to smoothly control to vary the speed. Therefore, it is hard for the compressor to control the amount of refrigerant compression per unit time in the compression mechanism desirably.

The present invention addresses a variable speed compressor having a variable speed mechanism by which the amount of refrigerant compression per unit time is desirably controlled in a compression mechanism.

### SUMMARY OF THE INVENTION

In accordance with the present invention, a variable speed compressor has a housing, a compression mechanism and a variable speed mechanism. The compression mechanism is contained in the housing for compressing gas. The variable speed mechanism is contained in the housing for controlling driving speed of the compression mechanism and includes an input shaft received in the housing and being rotatable around a first axis, an output shaft received in the input shaft and being rotatable around the first axis, a carrier provided in the housing and being rotatable around the first axis, planetary cones received by the carrier and each rotatable around a respective second axis which inclines to the first axis, and a control ring coaxial with the first axis to vary the speed of rotation of the planetary cones in such a way as to move in a direction parallel to the first axis. The speed of rotation of the input shaft is controllably transmittable to the output shaft by transmitting torque of the input shaft to the output shaft in such a way that the input shaft, the output shaft and the control ring are in contact with the planetary cones. The control ring having a cylindrical shape has a first pressure sensing surface coaxial with the first axis and a second pressure sensing surface coaxial with the first axis. The first pressure sensing surface and the second pressure sensing surface are formed on the opposite side of the control ring. The control ring senses pressure applied to the first pressure sensing surface and the second pressure sensing surface for movement.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a variable speed compressor according to a first preferred embodiment of the present invention;

FIG. 2 is an enlarged cross-sectional view of a pressure regulator of the variable speed compressor as seen radially of the compressor according to the first preferred embodiment of the present invention;

FIG. 3 is a partially longitudinal cross-sectional view of the variable speed compressor according to the first preferred embodiment of the present invention;

FIG. 4 is a partially longitudinal cross-sectional view of a variable speed compressor according to a second preferred embodiment of the present invention;

FIG. 5 is a partially longitudinal cross-sectional view of a variable speed compressor according to a third preferred embodiment of the present invention;

FIG. 6 is a partially longitudinal cross-sectional view of a variable speed compressor according to a fourth preferred embodiment of the present invention;

FIG. 7 is a partially longitudinal cross-sectional view of a variable speed compressor according to a fifth preferred embodiment of the present invention;

FIG. 8 is a partially longitudinal cross-sectional view of a variable speed compressor according to a sixth preferred embodiment of the present invention;

FIG. 9 is a partially longitudinal cross-sectional view of a variable speed compressor according to a seventh preferred embodiment of the present invention;

FIG. 10 is a partially longitudinal cross-sectional view of a variable speed compressor according to an eighth preferred embodiment of the present invention;

FIG. 11A is a schematic view of a control valve of the variable speed compressor according to first through third, fifth, seventh and eleventh preferred embodiments of the present invention;

FIG. 11B is a schematic view of a control valve of a variable speed compressor according to a ninth preferred embodiment of the present invention;

FIG. 11C is a schematic view of the control valve of the variable speed compressor according to second through fourth, sixth, eighth and eleventh preferred embodiments of the present invention;

FIG. 11D is a schematic view of a control valve of a variable speed compressor according to a tenth preferred embodiment of the present invention; and

FIG. 12 is a longitudinal cross-sectional view of a variable speed compressor according to an eleventh preferred embodiment.

### DETAILED DESCRIPTION OF THE PREFERRED EMBODIMENTS

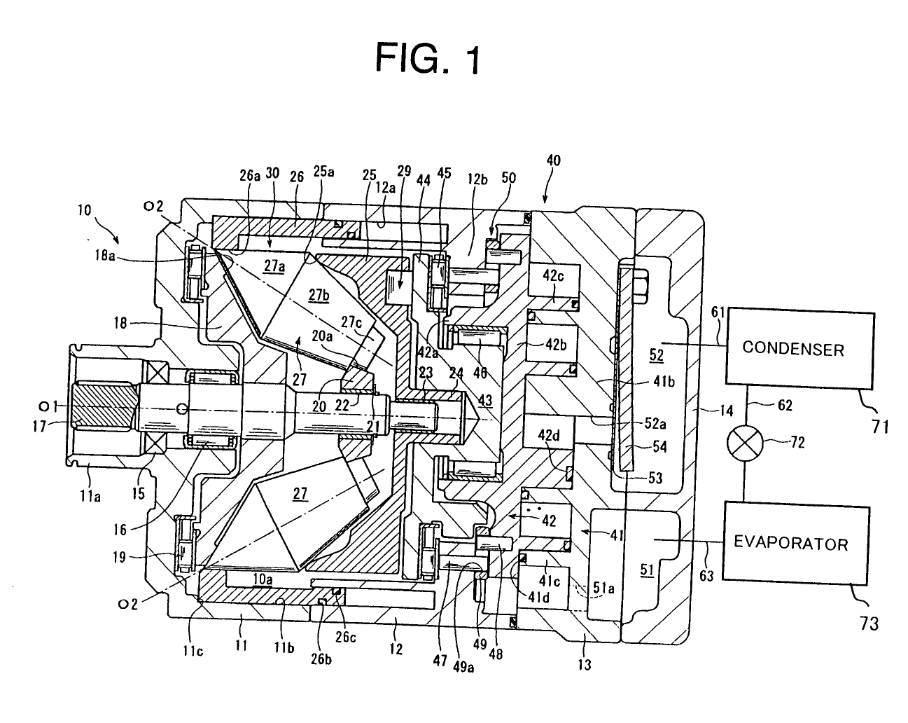

First through eleventh preferred embodiments of a variable speed compressor according to the present invention will now be described with reference to FIGS. 1 through 12.

The first preferred embodiment of the variable speed compressor will now be described. Referring to FIG. 1, the variable speed compressor includes a variable speed mechanism 30 and a scroll-type compression mechanism 40, which are integrated with each other. The variable speed compressor is a component of a vehicle air conditioner.

The variable speed compressor has a housing 10 including a front housing 11, a center housing 12, a shell 13, and a rear housing 14. The fronts housing 11 and the center housing 12 are connected together to define therein a control chamber 10a. The shell 13 is formed integrally with a fixed scroll member 41, which will be described later. A movable scroll member 42 is provided between the center housing 12 and the shell 13. The movable scroll member 42 will also be described later. The shell 13 and the rear housing 14 are connected with each other to define a suction chamber 51 and a discharge chamber 52. In addition, the left side of FIG. 1 indicates the front side and the right side of FIG. 1 indicates the rear side.

The front housing 11 has a boss 11a which receives therein the front end of an input shaft 17 through a seal 15 and a radial bearing 16 for rotation around a first axis O1. The rear end of the input shaft 17 extends into the control chamber 10a.

An input rotor 18 is press-fitted over the input shaft 17 in the control chamber 10a. A thrust bearing 19 is interposed between the front end of the input rotor 18 and the front housing 11. A pressing surface 18a is formed at the periphery of the input rotor 18 on the rear side. In addition, since the input rotor 18 is press-fitted over the input shaft 17, the input rotor 18 may be regarded as a part of the input shaft 17.

In the control chamber 10a, a carrier 20 is provided on the rear side of the input shaft 17 and inhibited from moving rearward by a circular clip 21. A bearing metal 22 is press-fitted into the carrier 20 and slidable on the input shaft 17. Hence, the carrier 20 is rotatable around the first axis O1. On the outer circumferential surface of the carrier 20, recessed and frusto-conical support surfaces 20a are formed. The number of the support surfaces 20a is equal to the number of the planetary cones 27.

Furthermore, in the control chamber 10a, an output shaft 24 is press-fitted over a bearing metal 23, while the input shaft 17 is inserted into the bearing metal 23. Thus, the output shaft 24 is so received as to be slidably rotatable around the first axis O1. The output shaft 24 is formed integrally with an output rotor 25 which extends radially and axially toward the side of the carrier 20. The output rotor 25 has a pressing surface 25a on the rear side of the periphery.

The center housing 12 has an annular cylinder 12a which extends in the direction parallel to the first axis O1 and coaxially therewith in such a way as to open toward the front housing 11. The cylinder 12a receives a cylindrical (or annular) control ring 26 reciprocably therein. Referring to FIG. 3, the control ring 26 has a first pressure sensing surface 26d, which is coaxial with the first axis O1, at the front end. The control ring 26 also has a second pressure sensing surface 26e, which is coaxial with the first axis O1, at the rear end. The first pressure sensing surface 26d and the second pressure sensing surface 26e are on the opposite sides of the control ring 26 and formed in annular end surfaces of the control ring 26 for uniformly receiving pressure. The first pressure sensing surface 26d is exposed to the control chamber 10a, while the second pressure sensing surface 26e is exposed to the cylinder 12a. The control ring 26 has a cylindrical pressing surface 26a formed on the inner circumferential surface of the control ring 26 at the front end. It is noted that the control ring 26 has seal rings 26b and 26c fitted near the rear end. The front housing 11 has a guide surface 11b for guiding the outer circumferential surface of the control ring 26 protruding from the cylinder 12a into the control chamber 10a. A stop surface 11c is formed at the front end of the guide surface 11b and may abut the front end surface of the control ring 26.

In the control chamber 10a, at least three planetary cones 27 are received at their rear ends by the carrier 20 in such a way as to be rotatable around respective second axes O2 which incline to the first axis O1. Then, each planetary cone 27 is pressed by the input rotor 18, the output rotor 25 and the control ring 26. Each planetary cone 27 has a conical control and receiving surface 27a, a frusto-conical actuating surface 27b, and a frusto-conical support surface 27c. The actuating surface 27b has a hypothetical vertex on the rear side and adjoins the control and receiving surface 27a at the front end. The support surface 27c has a hypothetical vertex on the rear side and adjoins the actuating surface 27b at the front end. The hypothetical vertex of each planetary cone 27 lies in the respective second axis O2, and each vertical angle of the hypothetical vertex is made acute.

The control and receiving surface 27a of each planetary cone 27 is in frictional contact with the pressing surface 18a of the input rotor 18 and also in frictional contact with the pressing surface 26a of the control ring 26. The actuating surface 27b of each planetary cone 27 is in frictional contact with the pressing surface 25a of the output rotor 25. The support surface 27c of each planetary cone 27 fits the support surface 20a of the carrier 20 respectively.

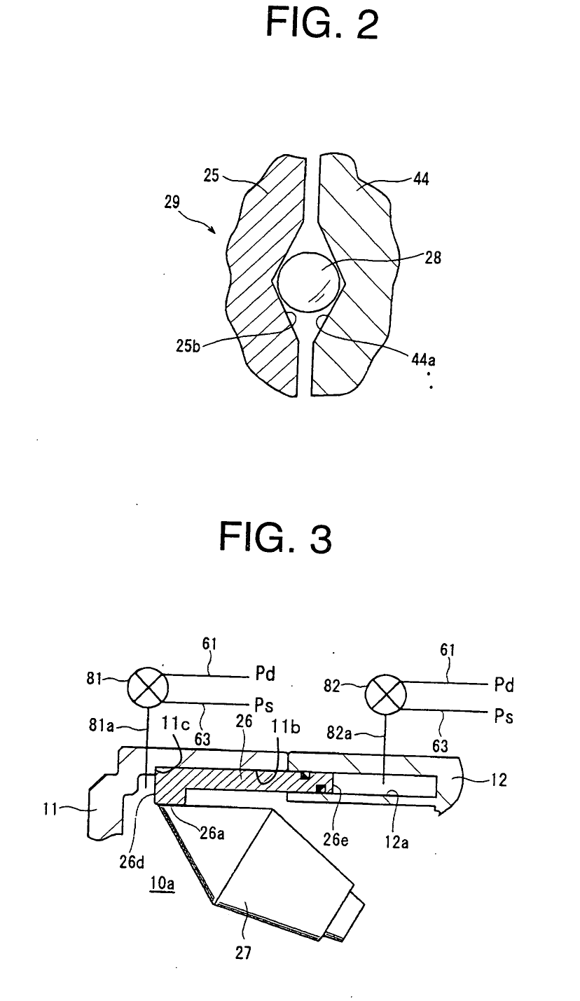

The output shaft 24 is eccentrically press-fitted into a cylindrical drive bushing 43. A drive rotor 44 is formed integrally with the drive bushing 43 at the rear end adjacent to the output rotor 25 and extends radially to face the output rotor 25. Referring to FIG. 2, the output rotor 25 has a groove 25b which is recessed on the rear end surface of the output rotor 25 and is less in depth as being distanced from the middle of the groove 25b in the circumferential direction of the output rotor 25. On the other hand, the drive rotor 44 has a groove 44a which is recessed on the front end of the drive rotor 44 in such a way as to have a plane symmetry with the groove 25b. The grooves 25b and 44a interpose a cylindrical roller 28 having an axis aligned in the radial direction of the compressor. In this variable speed compressor, six sets of these grooves 25b, 44a and roller 28 are provided at equiangular intervals in the circumferential direction. All sets of the grooves 25b, 44a and the roller 28 cooperate to form a pressure regulator 29. It is noted that the drive rotor 44 also features a counterbalance.

Thus, the housing 10, the input shaft 17, the input rotor 18, the carrier 20, the output shaft 24, the output rotor 25, the planetary cones 27, the control ring 26, and the pressure regulator 29, and the like, cooperate to form the variable speed mechanism 30.

Referring back to FIG. 1, the center housing 12 has an inner flange 12b extending toward the drive bushing 43. A thrust bearing 45 is interposed between the rear end surface of the drive rotor 44 and the front end surface of the inner flange 12b. On the other hand, a movable scroll member 42 is interposed between the inner flange 12b and the shell 13 on the outer circumferential surface of the drive bushing 43 through a radial bearing 46.

The movable scroll member 42 includes a boss 42a into which a radial bearing 46 is fitted, a disc-shaped movable base plate 42b extending radially and formed integrally with the boss 42a and a movable scroll wall 42c extending rearward from the movable base plate 42b in the direction parallel to the first axis O1. The movable scroll wall 42c is provided with a tip seal 42d made of PTFE (or polytetrafluoroethylene) at the distal end thereof.

Three or more fixed pins 47 are fixed to the rear end surface of the inner flange 12b in the direction parallel to the first axis O1, while the same number of movable pins 48 is fixed to the movable base plate 42b of the movable scroll member 42 in the direction parallel to the first axis O1. The same number of movable rings 49 are interposed between the inner flange 12b and the movable base plate 42b same as the fixed pins 47 and the movable pins 48. Each of the movable pins 49 has a through hole 49a. Each pair of the fixed pin 47 and the movable pin 48 is inserted in the respective through hole 49a to have an orbital radius of a distance between the axes of the pins 47, 48. These fixed pins 47, movable pins 48 and movable rings 49 cooperate to form a rotation prevention means 50.

The shell 13 is formed integrally with the fixed scroll member 41. The fixed scroll member 41 includes a disc-shaped fixed base plate 41b extending radially, and a fixed scroll wall 41c extending forward from the fixed base plate 41b and in the direction parallel to the first axis O1. The fixed scroll wall 41c is provided with a tip seal 41d made of PTFE at the distal end thereof.

The fixed scroll wall 41c and the movable scroll wall 42c have substantially the same length from the base plate to the distal end in the direction of the first axis O1. The movable scroll wall 42c is slidable on the fixed base plate 41b through the tip seals 41d and 42d.

The fixed base plate 41b has a discharge port 52a which is communicable with the discharge chamber 52 at the center portion of the fixed base plate 41b. A discharge valve 53 and a retainer 54 are fixed to the fixed base plate 41b in the discharge chamber 52 to close the discharge port 52a. A suction port 51a is formed through the outer portion of the fixed base plate 41b to communicate with the suction chamber 51.

The housing 10, the output shaft 24, the drive bushing 43, the drive rotor 44, the movable scroll member 42, the rotation prevention means 50 and the fixed scroll member 41, and the like, cooperate to form the compression mechanism 40.

In the vehicle air conditioner, the discharge chamber 52 is connected to a condenser 71 by a conduit 61. The condenser 71 is connected to an evaporator 73 through an expansion valve 72 by a conduit 62. The evaporator 73 is connected to the suction chamber 51 by a conduit 63. In addition, as shown in FIG. 3, the conduits 61 and 63 each are connected to control valves 81, 82.

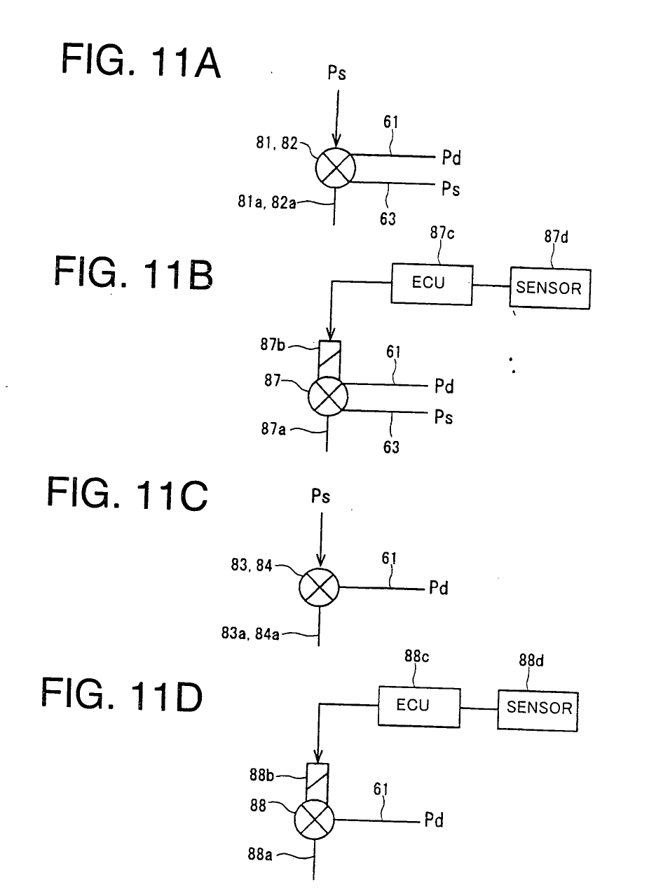

Alternatively, either the discharge chamber 52 or suction chamber 51, or both of them may be connected to the control valves 81, 82 through a passage formed in the housing 10. Referring to FIG. 11A, the control valve 81 is operable to allow the conduit 61 or conduit 63 to communicate with a passage 81a in such a way that suction pressure Ps of refrigerant causes a valve body (not shown) of the control valve 81 to move. Thus, the control ring 26 is movable based upon suction pressure Ps. Similarly, the control valve 82 is operable to allow the conduit 61 or conduit 63 to communicate with a passage 82a in such a way that suction pressure Ps of refrigerant causes a valve body (not shown) of the control valve 82 to move. Also, the control ring 26 is movable based upon suction pressure Ps.

Referring to FIG. 3, the passage 81a of the control valve 81 communicates with the control chamber 10a, while the passage 82a of the control valve 82 communicates with the cylinder 12a on the side of the second pressure sensing surface 26e of the control ring 26.

In the above described variable speed compressor, referring to FIG. 1, while the input shaft 17 of the variable speed mechanism 30 is being driven around the first axis O1 by a vehicle engine or motor, the input rotor 18 presses the control and receiving surfaces 27a to rotate each planetary cone 27 around the respective second axis O2, and the output rotor 25 pressing the actuating surfaces 27b rotates reversely around the first axis O1. Thus, the rotation of the output rotor 25 is transmitted to the output shaft 24.

Therefore, in the compression mechanism 40, the output shaft 24 is driven so that the drive bushing 43 is eccentrically turned around the axis thereof, with the result that the movable scroll member 42 is orbited without rotating the movable scroll member 42 by the rotation prevention means 50. Then, compression chambers formed between the fixed scroll member 41 and the movable scroll member 42 are progressively reduced in volume from the outer side of the scroll members 41, 42 to the center. This causes refrigerant in the suction chamber 51 to be compressed in the compression chambers and discharged to the discharge chamber 52. Refrigerant in the discharge chamber 52 is sent to the condenser 71 and then to the evaporator 73 for vehicle cooling.

Meanwhile, in the variable speed mechanism 30, to the output shaft 24 is transmitted an angular velocity (A-B) resulting from a differential between an angular velocity (A) for turning the output shaft 24 reversely relative to the input rotor 18 by the rotation of the planetary cones 27 and an angular velocity (B) for turning the output shaft 24 forward relative to the input rotor 18 by the orbital motion of the planetary cones 27. Specifically, when the control ring 26 is in frictional contact with the smaller diameter portion of the control and receiving surface 27a of each planetary cone 27, each planetary cone 27 makes a larger differential between the angular velocity (A) and the angular velocity (B), with the result that the output shaft 24 rotates at a higher speed. On the other hand, when the control ring 26 is in frictional contact with the larger diameter portion of the control and receiving surface 27a of each planetary cone 27, each planetary cone 27 makes a smaller differential between the angular velocity (A) and the angular velocity (B), with the result that the output shaft 24 rotates at a lower speed.

In the meantime, in the pressure regulator 29, each roller 28 rolls toward the shallow portion of the grooves 25b, 44a in response to torque applied between the output rotor 25 and the drive rotor 44 to urge the output rotor 25 toward the planetary cones 27. Therefore, the input rotor 18, the control ring 26, and the output rotor 25 are pressed toward the planetary cones 27 by the force corresponding to the torque, thereby preventing relative sliding between the planetary cones 27 and the input rotor 18, between the planetary cones 27 and the control ring 26 and between the planetary cones 27 and the output rotor 25.

This variable speed compressor, in the variable speed mechanism 30, permits torque of the input shaft 17 to be transmitted to the output shaft 24, while the rotating speed of the input shaft 17 can be varied for transmission to the output shaft 24, with the result that the amount of refrigerant compression per unit time is controlled in the compression mechanism 40.

Meanwhile, in the vehicle air conditioner, when suction pressure Ps becomes high due to high thermal load, the control valve 81 shown in FIG. 3 allows the conduit 63 to communicate with the passage 81a, while the control valve 82 allows the conduit 61 to communicate with the passage 82a. Thus, suction pressure Ps which is relatively low in pressure is introduced into the control chamber 10a, while discharge pressure Pd which is relatively high in pressure is introduced into the cylinder 12a. The control ring 26 then senses suction pressure Ps on the first pressure sensing surface 26d and discharge pressure Pd on the second pressure sensing surface 26e. Hence, the control ring 26 proceeds into the control chamber 10a with parallel to the first axis O1. Thus, the control ring 26 is in frictional contact with the smaller diameter portion of the control and receiving surface 27a of each planetary cone 27, and the output shaft 24 rotates at a higher speed, with the result that the amount of refrigerant compression per unit time is increased in the compression mechanism 40.

On the other hand, when suction pressure Ps becomes low due to low thermal load, the control valve 81 allows the conduit 61 to communicate with the passage 81a, and the control valve 82 allows the conduit 63 to communicate with the passage 82a. Thus, discharge pressure Pd is introduced into the control chamber 10a, while suction pressure Ps is introduced into the cylinder 12a. The control ring 26 then senses discharge pressure Pd on the first pressure sensing surface 26d and suction pressure Ps on the second pressure sensing surface 26e. Hence, the control ring 26 recedes into the cylinder 12a with parallel to the first axis O1. Thus, the control ring 26 is in frictional contact with the larger diameter portion of the control and receiving surface 27a of each planetary cone 27, and the output shaft 24 rotates at a lower speed, with the result that the amount of refrigerant compression per unit time is reduced in the compression mechanism 40.

Accordingly, this variable speed compressor is operable to effectively control the amount of refrigerant compression per unit time in the compression mechanism 40 by the internal pressure thereof. In addition, in the variable speed compressor, since the housing 10 has the control chamber 10a, and the first pressure sensing surface 26d of the control ring 26 is exposed to the control chamber 10a, no space is required for exclusively applying suction pressure Ps or discharge pressure Pd to the first pressure sensing surface 26d. This causes a simple structure of the compressor, resulting in low manufacturing cost.

Furthermore, the variable speed compressor does not require an additional power source for control of the amount of refrigerant compression per unit time in the compression mechanism. This causes a simple structure of a vehicle air conditioner, resulting in low manufacturing cost and low running cost.

Alternatively, another control valve, instead of the control valve 81, 82, may be operable to allow the conduit 61 or conduit 63 to communicate with the passage 81a, 82a in such a way that discharge pressure Pd of refrigerant causes a valve body (not shown) of the control valve to move.

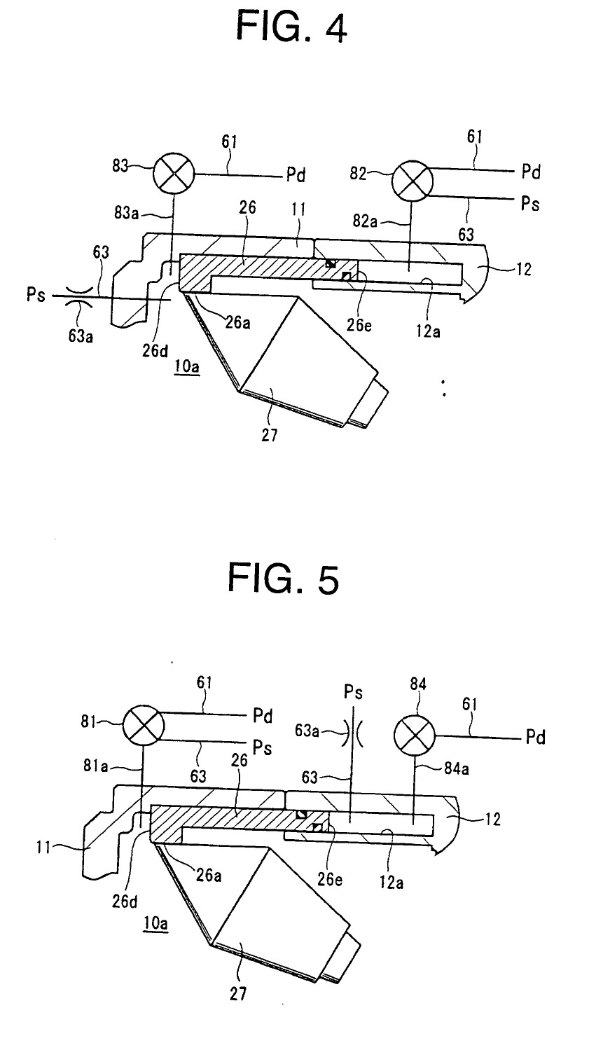

The second preferred embodiment of the variable speed compressor will now be described. Referring to FIG. 4, the conduit 61 is connected to a control valve 83 and the control valve 82, while the conduit 63 is connected to the control valve 82. Alternatively, the discharge chamber 52 and the suction chamber 51 may be in communication with the control valves 83, 82 through a passage formed in the housing 10. The control valve 83, as shown in FIG. 11C, is operable to allow the conduit 61 to communicate with a passage 83a in such a way that a valve body (not shown) of the control valve 83 is moved by suction pressure Ps.

Referring to FIG. 4, the passage 83a of the control valve 83 communicates with the control chamber 10a, while the passage 82a of the control valve 82 communicates with the cylinder 12a on the side of the second pressure sensing surface 26e of the control ring 26. The conduit 63 communicates with the control chamber 10a through a fixed throttle 63a.

Alternatively, the suction chamber 51 may communicate with the control chamber 10a through a passage which has a fixed throttle formed in the housing 10. The same reference numerals denote substantially similar components to those of the first preferred embodiment and the description is omitted.

In the above described variable speed compressor, when suction pressure Ps becomes high, the control valve 83 closes the conduit 61, while the control valve 82 allows the conduit 61 to communicate with the passage 82a. Therefore, suction pressure Ps which is relatively low in pressure is introduced into the control chamber 10a, while discharge pressure Pd which is relatively high in pressure is introduced into the cylinder 12a. Thus, the amount of refrigerant compression per unit time is increased in the compression mechanism 40.

In contrast, when suction pressure Ps becomes low, the control valve 83 allows the conduit 61 to communicate with the passage 83a, while the control valve 82 allows the conduit 63 to communicate with the passage 82a. Therefore, discharge pressure Pd is introduced into the control chamber 10a, while suction pressure Ps is introduced into the cylinder 12a. Thus, the amount of refrigerant compression per unit time is reduced in the compression mechanism 40.

The other advantages are the same as those of the variable speed compressor of the first preferred embodiment. Alternatively, another control valve, instead of the control valve 83, may be operable to allow the conduit 61 to communicate with the passage 83a in such a way that discharge pressure Pd of refrigerant causes a valve body (not shown) of the control valve to move. Alternatively, another control valve, instead of the control valve 82, may be operable to allow the conduit 61 or conduit 63 to communicate with the passage 83a in such a way that discharge pressure Pd of refrigerant causes a valve body (not shown) of the control valve to move.

The third preferred embodiment of the variable speed compressor will now be described. Referring to FIG. 5, the conduit 61 is connected to the control valve 81 and a control valve 84, while the conduit 63 is connected to the control valve 81. Alternatively, the discharge chamber 52 and the suction chamber 51 may be connected to the control valves 81, 84 through a passage formed in the housing 10. The control valve 84, as shown in FIG. 11C, is operable to allow the conduit 61 to communicate with the passage 84a in such a way that suction pressure Ps of refrigerant causes a valve body (not shown) of the control valve 84 to move.

Referring to FIG. 5, the passage 81a of the control valve 81 communicates with the control chamber 10a, and the passage 84a of the control valve 84 communicates with the cylinder 12a on the side of the second pressure sensing surface 26e of the control ring 26. The conduit 63 communicates with the cylinder 12a through the fixed throttle 63a. Alternatively, the suction chamber 51 may communicate with the cylinder 12a through a passage having a fixed throttle formed in the housing 10. The same reference numerals denote substantially similar components to those of the first preferred embodiment and the description is omitted.

In the above described variable speed compressor, when suction pressure Ps becomes high, the control valve 81 allows the conduit 63 to communicate with the passage 81a, while the control valve 84 allows the conduit 61 to communicate with the passage 84a. Therefore, suction pressure Ps which is relatively low in pressure is introduced into the control chamber 10a, while discharge pressure Pd which is relatively high in pressure is introduced into the cylinder 12a. Thus, the amount of refrigerant compression per unit time is increased in the compression mechanism 40.

In contrast, when suction pressure Ps becomes low, the control valve 81 allows the conduit 61 to communicate with the passage 81a, while the control valve 84 closes the conduit 61. Thus, discharge pressure Pd is introduced into the control chamber 10a, while suction pressure Ps is introduced into the cylinder 12a. Thus, the amount of refrigerant compression per unit time is reduced in the compression mechanism 40.

The other advantages are the same as those of the variable speed compressor of the first preferred embodiment. Alternatively, another control valve, instead of the control valve 81, may be operable to allow the conduit 61 or conduit 63 to communicate with the passage 81a in such a way that discharge pressure Pd of refrigerant causes a valve body (not shown) of the control valve to move. Alternatively, another control valve, instead of the control valve 84, may be operable to allow the conduit 61 to communicate with the passage 84a in such a way that discharge pressure Pd of refrigerant causes a valve body (not shown) of the control valve to move.

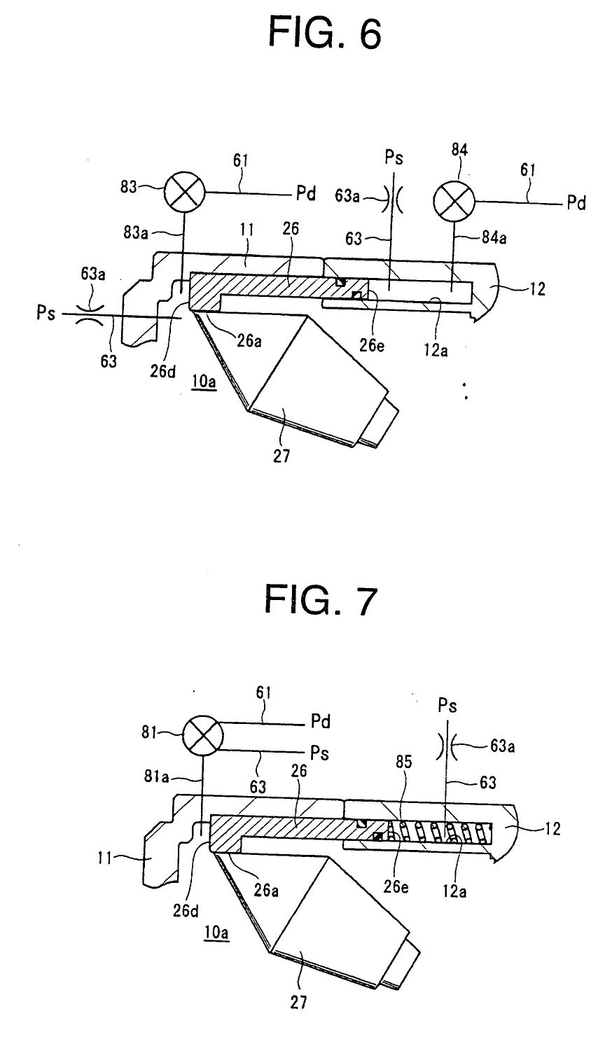

The fourth preferred embodiment of the variable speed compressor will now be described. Referring to FIG. 6, the conduit 61 is connected to the control valve 83 and the control valve 84. Alternatively, the discharge chamber 52 may be connected to the control valves 83, 84 through a passage formed in the housing 10.

The passage 83a of the control valve 83 communicates with the control chamber 10a, and the passage 84a of the control valve 84 communicates with the cylinder 12a on the side of the second pressure sensing surface 26e of the control ring 26. The conduit 63 communicates with the control chamber 10a and the cylinder 12a through the fixed throttle 63a. Alternatively, the suction chamber 51 may communicate with the control chamber 10a and the cylinder 12a through a passage having a fixed throttle, formed in the housing 10. The same reference numerals denote substantially similar components to those of the first preferred embodiment and the description is omitted.

In the above described variable speed compressor, when suction pressure Ps becomes high, the control valve 83 closes the conduit 61, while the control valve 84 allows the conduit 61 to communicate with the passage 84a. Therefore, suction pressure Ps which is relatively low in pressure is introduced into the control chamber 10a, while discharge pressure Pd which is relatively high in pressure is introduced into the cylinder 12a. Thus, the amount of refrigerant compression per unit time is increased in the compression mechanism 40.

In contrast, when suction pressure Ps becomes low, the control valve 83 allows the conduit 61 to communicate with the passage 83a, while the control valve 84 closes the conduit 61. Thus, discharge pressure Pd is introduced into the control chamber 10a, while suction pressure Ps is introduced into the cylinder 12a. Thus, the amount of refrigerant compression per unit time is reduced in the compression mechanism 40.

The other advantages are the same as those of the variable speed compressor of the first preferred embodiment. Alternatively, another control valve, instead of the control valve 83, may be operable to allow the conduit 61 to communicate with the passage 83a in such a way that discharge pressure Pd of refrigerant causes a valve body (not shown) of the control valve to move. Similarly, another control valve, instead of the control valve 84, may be operable to allow the conduit 61 to communicate with the passage 84a in such a way that discharge pressure Pd of refrigerant causes a valve body (not shown) of the control valve to move.

The fifth preferred embodiment of the variable speed compressor will now be described. Referring to FIG. 7, the conduit 61 and the conduit 63 are connected to the control valve 81. Alternatively, either the discharge chamber 52 or suction chamber 51, or both of them may be connected to the control valve 81 through a passage formed in the housing 10.

The passage 81a of the control valve 81 communicates with the control chamber 10a. A spring 85, or urging means, is provided in the cylinder 12a for urging the second pressure sensing surface 26e of the control ring 26 toward the control chamber 10a. In other words, the second pressure sensing surface 26e of the control ring 26 is urged by the spring 85 so that the compression mechanism 40 is driven at a maximum speed. The conduit 63 communicates with the cylinder 12a on the side of the second pressure sensing surface 26e of the control ring 26 through the fixed throttle 63a. Alternatively, the suction chamber 51 may communicate with the cylinder 12a through a passage which has a fixed throttle formed in the housing 10. The same reference numerals denote substantially similar components to those of the first preferred embodiment and the description is omitted.

In the above described variable speed compressor, when suction pressure Ps becomes high, the control valve 81 allows the conduit 63 to communicate with the passage 81a. Therefore, suction pressure Ps which is relatively low in pressure is introduced into the control chamber 10a, and the control ring 26 proceeds into the control chamber 10a by the urging force of the spring 85. Thus, the amount of refrigerant compression per unit time is increased in the compression mechanism 40.

In contrast, when suction pressure Ps becomes low, the control valve 81 allows the conduit 61 to communicate with the passage 81a. Therefore, discharge pressure Pd which is relatively high in pressure is introduced into the control chamber 10a, and the control ring 26 recedes into the cylinder 12a against the urging force of the spring 85. Thus, the amount of refrigerant compression per unit time is reduced in the compression mechanism 40. In addition, when the variable speed compressor is stopped, the first pressure sensing surface 26d of the control ring 26 is contacted with the stop surface 11c by the urging force of the spring 85.

Therefore, the variable speed compressor enables starting at a maximum speed. The other advantages are the same as those of the variable speed compressor of the first preferred embodiment. Alternatively, another control valve, instead of the control valve 81, may be operable to allow the conduit 61 or conduit 63 to communicate with the passage 81a in such a way that discharge pressure Pd of refrigerant causes a valve body (not shown) of the control valve to move.

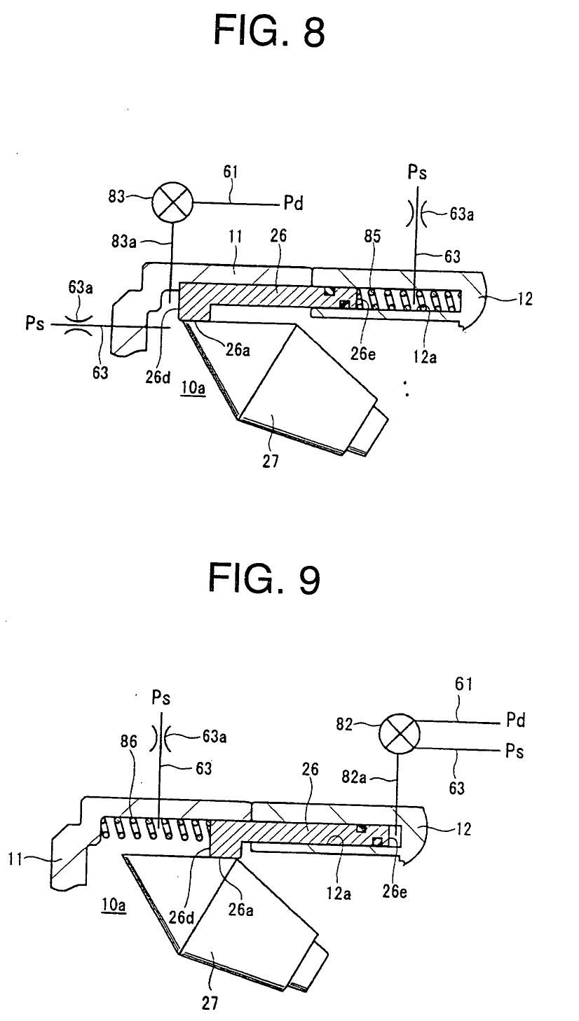

The sixth preferred embodiment of the variable speed compressor will now be described. Referring to FIG. 8, the conduit 61 is connected to the control valve 83. Alternatively, the discharge chamber 52 may be connected to the control valve 83 through a passage formed in the housing 10.

The passage 83a of the control valve 83 communicates with the control chamber 10a. The spring 85 is provided in the cylinder 12a for urging the second pressure sensing surface 26e of the control ring 26 toward the control chamber 10a. In other words, the second pressure sensing surface 26e of the control ring 26 is urged by the spring 85 so that the compression mechanism 40 is driven at a maximum speed. The conduit 63 communicates with the control chamber 10a and the cylinder 12a on the side of the second pressure sensing surface 26e of the control ring 26 through the fixed throttle 63a. Alternatively, the suction chamber 51 may communicate with the control chamber 10a and the cylinder 12a through a passage which has a fixed throttle formed in the housing 10. The same reference numerals denote substantially similar components to those of the first preferred embodiment and the description is omitted.

In the above described variable speed compressor, when suction pressure Ps becomes high, the control valve 83 closes the conduit 61. Therefore, suction pressure Ps which is relatively low in pressure is introduced into the control chamber 10a and the cylinder 12a through the conduit 63 having the fixed throttle 63a, and the control ring 26 proceeds into the control chamber 10a by the urging force of the spring 85. Thus, the amount of refrigerant compression per unit time is increased in the compression mechanism 40.

In contrast, when suction pressure Ps becomes low, the control valve 83 allows the conduit 61 to communicate with the passage 83a. Therefore, discharge pressure Pd which is relatively high in pressure is introduced into the control chamber 10a, and the control ring 26 recedes into the cylinder 12a against the urging force of the spring 85. Thus, the amount of refrigerant compression per unit time is reduced in the compression mechanism 40. In addition, when the variable speed compressor is stopped, the first pressure sensing surface 26d of the control ring 26 is contacted with the stop surface 11c by the urging force of the spring 85.

Therefore, the variable speed compressor enables starting at a maximum speed. The other advantages are the same as those of the variable speed compressor of the first preferred embodiment. Alternatively, another control valve, instead of the control valve 83, is operable to allow the conduit 61 to communicate with the passage 83a in such a way that discharge pressure Pd of refrigerant causes a valve body (not shown) of the control valve to move.

The seventh preferred embodiment of the variable speed compressor will now be described. Referring to FIG. 9, the conduit 61 and the conduit 63 are connected to the control valve 82. Alternatively, either the discharge chamber 52 or suction chamber 51, or both of them may be connected to the control valve 82 through a passage formed in the housing 10.

The passage 82a of the control valve 82 communicates with the cylinder 12a on the side of the second pressure sensing surface 26e of the control ring 26. A spring 86, or urging means, is provided in the control chamber 10a for urging the first pressure sensing surface 26d of the control ring 26 toward the cylinder 12a. That is, the first pressure sensing surface 26d of the control ring 26 is urged by the spring 86 so that the compression mechanism 40 is driven at a minimum speed. The conduit 63 communicates with the control chamber 10a through the fixed throttle 63a. Alternatively, the suction chamber 51 may communicate with the control chamber 10a through a passage which has a fixed throttle formed in the housing 10. The same reference numerals denote substantially similar components to those of the first preferred embodiment and the description is omitted.

In the above described variable speed compressor, when suction pressure Ps becomes high, the control valve 82 allows the conduit 61 to communicate with the passage 82a. Therefore, discharge pressure Pd which is relatively high in pressure is introduced into the cylinder 12a, and the control ring 26 proceeds into the control chamber 10a against the urging force of the spring 86. Thus, the amount of refrigerant compression per unit time is increased in the compression mechanism 40.

In contrast, when suction pressure Ps becomes low, the control valve 82 allows the conduit 63 to communicate with the passage 82a. Therefore, suction pressure Ps which is relatively low in pressure is introduced into the control chamber 10a and the cylinder 12a, and the control ring 26 recedes into the cylinder 12a by the urging force of the spring 86. Thus, the amount of refrigerant compression per unit time is reduced in the compression mechanism 40. In addition, when the variable speed compressor is stopped, the control ring 26 recedes into the cylinder 12a by the urging force of spring 86.

Therefore, the variable speed compressor enables starting at a minimum speed. The other advantages are the same as those of the variable speed compressor of the first preferred embodiment. Alternatively, another control valve, instead of the control valve 82, may be operable to allow the conduit 61 or conduit 63 to communicate with the passage 81a in such a way that discharge pressure Pd of refrigerant causes a valve body (not shown) of the control valve to move.

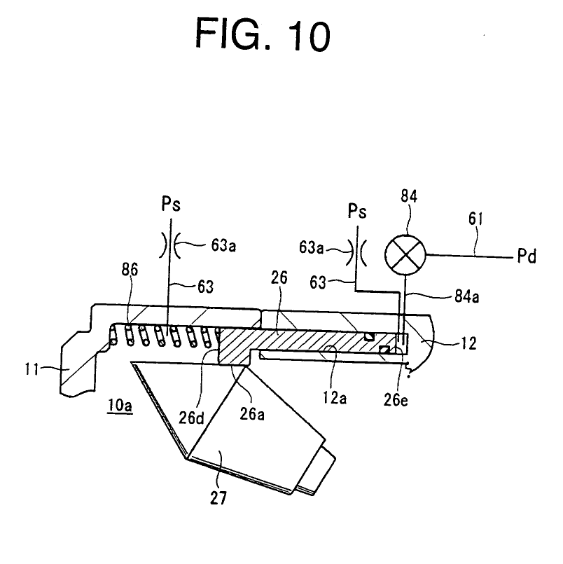

The eighth preferred embodiment of the variable speed compressor will now be described. Referring to FIG. 10, the conduit 61 is connected to the control valve 84. Alternatively, the discharge chamber 52 may be connected to the control valve 84 through a passage formed in the housing 10.

The passage 84a of the control valve 84 communicates with the cylinder 12a on the side of the second pressure sensing surface 26e of the control ring 26. The spring 86, or urging means, is provided in the control chamber 10a for urging the first pressure sensing surface 26d of the control ring 26 toward the cylinder 12a. That is, the first pressure sensing surface 26d of the control ring 26 is urged by the spring 86 so that the compression mechanism 40 is driven at a minimum speed. The conduit 63 communicates with the control chamber 10a and the cylinder 12a through the fixed throttle 63a.

Alternatively, the suction chamber 51 may communicate with the control chamber 10a and the cylinder 12a through a passage which has a fixed throttle formed in the housing 10. The same reference numerals denote substantially similar components to those of the first preferred embodiment and the description is omitted.

In the above described variable speed compressor, when suction pressure Ps becomes high, the control valve 84 allows the conduit 61 to communicate with the passage 84a. Therefore, discharge pressure Pd which is relatively high in pressure is introduced into the cylinder 12a, and the control ring 26 proceeds into the control chamber 10a against the urging force of the spring 86. Thus, the amount of refrigerant compression per unit time is increased in the compression mechanism 40.

In contrast, when suction pressure Ps becomes low, the control valve 84 closes the conduit 61. Therefore, the control ring 26 recedes into the cylinder 12a by the urging force of the spring 86. Thus, the amount of refrigerant compression per unit time is reduced in the compression mechanism 40. In addition, when the variable speed compressor is stopped, the control ring 26 recedes into the cylinder 12a by the urging force of spring 86.

Therefore, the variable speed compressor also enables starting at a minimum speed. The other advantages are the same as those of the variable speed compressor of the first preferred embodiment. Alternatively, another control valve, instead of the control valve 84, may be operable to allow the conduit 61 to communicate with the passage 84a in such a way that discharge pressure Pd of refrigerant causes a valve body (not shown) of the control valve to move.

The ninth preferred embodiment of the variable speed compressor will now be described. A control valve 87 shown in FIG. 11B is used in any one of the first through eighth preferred embodiments instead of the control valves 81, 82 shown in FIG. 11A.

This control valve 87 has a solenoid 87b, which is electrically connected through an ECU (electric control unit) 87c to a sensor 87d. The sensor 87d used for the control valve 87 is operable to detect external information such as a manipulated signal, an acceleration signal, a speed signal, temperature and humidity. Alternatively, the control valve 87 may be operable to open and close a passage 87a only by the solenoid 87b, or may be operable to detect suction pressure Ps or discharge pressure Pd and to open and close the passage 87a.

Thus, the control ring 26 is movable based upon the external information. This variable speed compressor is operable to control the amount of refrigerant compression per unit time in the compression mechanism in accordance with operator's taste, driving condition of vehicles, and the like. The other advantages are the same as those of the variable speed compressor of the first preferred embodiment.

The tenth preferred embodiment of the variable speed compressor will now be described. A control valve 88 shown in FIG. 11D is used in any one of the first through eighth preferred embodiments instead of the control valves 83, 84 shown in FIG. 11C.

This control valve 88 has a solenoid 88b, which is electrically connected through an ECU (electric control unit) 88c to a sensor 88d. The sensor 88d used for the control valve 88 is operable to detect external information such as a manipulated signal, an acceleration signal, a speed signal, temperature and humidity. Alternatively, the control valve 88 may be operable to open and close a passage 88a only by the solenoid 88b, or may be operable to detect suction pressure Ps or discharge pressure Pd and to open and close the passage 88a.

Thus, the control ring 26 is movable based upon the external information. This variable speed compressor is operable to control the amount of refrigerant compression per unit time in the compression mechanism 40 in accordance with operator's taste, driving condition of vehicles, and the like. The other advantages are the same as those of the variable speed compressor of the first preferred embodiment.

In the first through tenth preferred embodiments, suction pressure Ps or discharge pressure Pd is introduced into the control chamber. In an alternative embodiment, discharge pressure Pd is varied as intermediate pressure through a throttle, and then suction pressure Ps or intermediate pressure may be introduced into the control chamber.

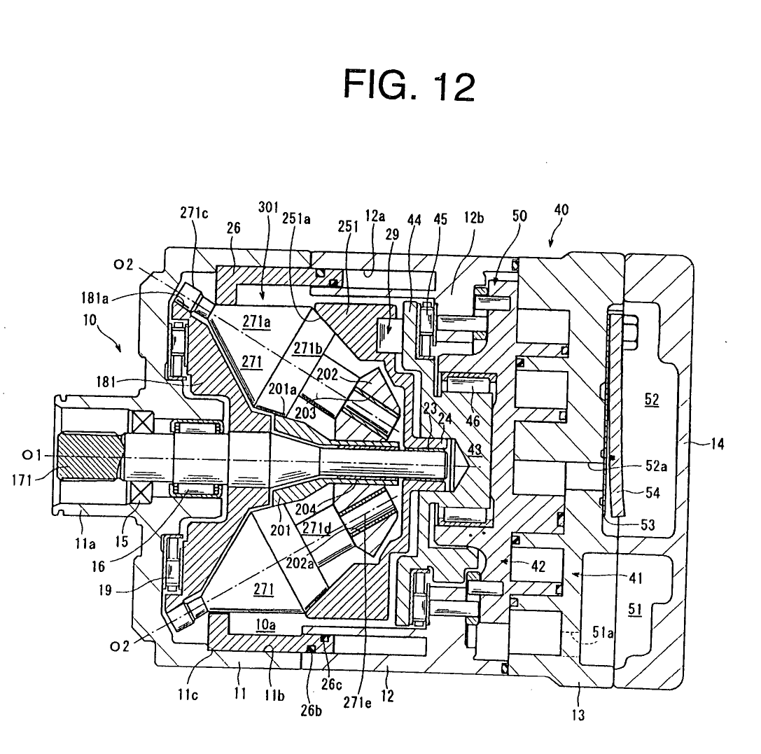

The eleventh preferred embodiment of the variable speed compressor will now be described. A variable speed mechanism 301 shown in FIG. 12 is used in the compressor.

In this variable speed compressor, an input rotor 181 is press-fitted over an input shaft 171 in the control chamber 10a. A pressing surface 181a is formed at the periphery of the input rotor 181 on the rear side. A bearing metal 204 is press-fitted over a first carrier 201, thus the input shaft 171 is slidable on the first carrier 201. A second carrier 202 which has shaft holes 202a is fitted over the first carrier 201. Each shaft hole 202a has a bearing metal 203 press-fitted into the inner circumferential surface of the shaft hole 202a. The number of the shaft holes 202a is equal to the number of planetary cones 271 which will be described later. Frusto-conical support surfaces 201a are recessed on the first carrier 201 on the side of input rotor 181, and the number of the support surfaces 201a is equal to the number of the planetary cones 271.

An output rotor 251 is formed integrally with the output shaft 24 and extends radially on the side of the second carrier 202. A pressing surface 251a is formed at the periphery of the output rotor 251 on the front side.

In the control chamber 10a, at least three planetary cones 27 are supported at their rear ends by the first and second carriers 201, 202 in such a way as to be rotatable around the respective second axes O2. Then, each planetary cone 271 is pressed by the input rotor 181, output rotor 251 and control ring 26.

Each planetary cone 271 has a frusto-conical control surface 271a, a frusto-conical actuating surface 271b, a frusto-conical receiving surface 271c, a cylindrical intermediate surface 271d and a cylindrical shaft 271e. The control surface 271a has a hypothetical vertex on the front side. The actuating surface 271b has a hypothetical vertex on the rear side and adjoins the control surface 271a at the front end. The receiving surface 271c is formed on the front side of the control surface 271a. The intermediate surface 271d is formed on the rear end of the actuating surface 271b through a step. The shaft 271e is formed on the rear end of the intermediate surface 271d through a step. The hypothetical vertex of each planetary cone 271 lies on the respective second axis O2, and each vertical angle of the hypothetical vertex is made acute.

The receiving surface 271c of each planetary cone 271 is in frictional contact with the pressing surface 181a of the input rotor 181. The control surface 271a of each planetary cone 271 is in frictional contact with the pressing surface 26a of the control ring 26. The actuating surface 271b of each planetary cone 27 is in frictional contact with the pressing surface 251a of the output rotor 251 and fits a support surface 201a of the first carrier 201. The shaft 271e of each planetary cone 271 fits the inner circumferential surface of the bearing metal 203 of the second carrier 202. The same reference numerals denote substantially similar components to those of the first through tenth preferred embodiments and the description is omitted.

This variable speed compressor permits a larger transmission ratio. The other advantages are the same as those of the variable speed compressor of the first through tenth preferred embodiments.

The present invention is not limited to the embodiments described above but may be modified into the following alternative embodiment.

In an alternative embodiment, a ball bearing or roller bearing, instead of the bearing metal, is applicable.

Therefore, the present examples and embodiments are to be considered as illustrative and not restrictive, and the invention is not to be limited to the details given herein but may be modified within the scope of the appended claims.

1. A variable speed compressor comprising:
a housing;
a compression mechanism contained in the housing for compressing gas; and
a variable speed mechanism contained in the housing for controlling driving speed of the compression mechanism, the variable speed mechanism including:
an input shaft received in the housing and being rotatable around a first axis;
an output shaft received in the input shaft and being rotatable around the first axis;
a carrier provided in the housing and being rotatable around the first axis;
planetary cones received by the carrier and each rotatable around a respective second axis which inclines to the first axis; and
a cylindrical control ring coaxial with the first axis and operable to move in a direction parallel to the first axis for varying the speed of rotation of the planetary cones, wherein the speed of rotation of the input shaft is controllably transmittable to the output shaft by transmitting torque of the input shaft to the output shaft in such a way that the input shaft, the output shaft and the control ring are in contact with the planetary cones, wherein the control ring has a first pressure sensing surface coaxial with the first axis and a second pressure sensing surface coaxial with the first axis, wherein the first pressure sensing surface and the second pressure sensing surface are on the opposite side of the control ring, and wherein the control ring senses pressure applied to the first pressure sensing surface and the second pressure sensing surface for movement.

2. The variable speed compressor according to claim 1, wherein the first pressure sensing surface and the second pressure sensing surface sense at lease one of suction pressure and discharge pressure by the compression mechanism.

3. The variable speed compressor according to claim 2, wherein the housing has a control chamber where the suction pressure or discharge pressure is operably applied, and wherein one of the first pressure sensing surface and the second pressure sensing surface is exposed in the control chamber.

4. The variable speed compressor according to claim 3, wherein the housing has a cylinder where the control ring is received, wherein the suction pressure or discharge pressure is operably applied to the cylinder, and wherein the other one of the first pressure sensing surface and the second pressure sensing surface is exposed in the cylinder.

5. The variable speed compressor according to claim 4, wherein the variable speed mechanism further includes:
a first control valve selective to apply the suction pressure or discharge pressure to the control chamber; and
a second control valve selective to apply the suction pressure or discharge pressure to the cylinder.

6. The variable speed compressor according to claim 4, wherein the variable speed mechanism further includes:
a first control valve selective to apply the discharge pressure to the control chamber; and
a second control valve selective to apply the suction pressure or discharge pressure to the cylinder, wherein the suction pressure is applied to the control chamber through a fixed throttle.

7. The variable speed compressor according to claim 4, wherein the variable speed mechanism further includes:
a first control valve selective to apply the suction pressure or discharge pressure to the control chamber; and
a second control valve selective to apply the discharge pressure to the cylinder, wherein the suction pressure is applied to the cylinder through a fixed throttle.

8. The variable speed compressor according to claim 4, wherein the variable speed mechanism further includes:
a first control valve selective to apply the discharge pressure to the control chamber; and
a second control valve selective to apply the discharge pressure to the cylinder, wherein the suction pressure is applied to the control chamber and the cylinder through a fixed throttle.

9. The variable speed compressor according to claim 4, wherein the variable speed mechanism further includes:
a control valve selective to apply the suction pressure or discharge pressure to the control chamber where the first pressure sensing surface is exposed; and
an urging means provided in the cylinder for applying urging force to the second pressure sensing surface, wherein the suction pressure is applied to the cylinder through a fixed throttle.

10. The variable speed compressor according to claim 4, wherein the variable speed mechanism further includes:
a control valve selective to apply the discharge pressure to the control chamber where the first pressure sensing surface is exposed; and
an urging means provided in the cylinder for applying urging force to the second pressure sensing surface, wherein the suction pressure is applied to the control chamber and the cylinder through a fixed throttle.

11. The variable speed compressor according to claim 4, wherein the variable speed mechanism further includes:
a control valve selective to apply the suction pressure or discharge pressure to the cylinder where the second pressure sensing surface is exposed; and
an urging means provided in the control chamber for applying urging force to the first pressure sensing surface, wherein the suction pressure is applied to the control chamber through a fixed throttle.

12. The variable speed compressor according to claim 4, wherein the variable speed mechanism further includes:
a control valve selective to apply the discharge pressure to the cylinder where the second pressure sensing surface is exposed; and
an urging means provided in the control chamber for applying urging force to the first pressure sensing surface, wherein the suction pressure is applied to the control chamber and the cylinder through a fixed throttle.

13. The variable speed compressor according to claim 4, wherein the variable speed mechanism further includes:
a control valve selective to apply the suction pressure or discharge pressure by a pressure sensing means provided in the control valve.

14. The variable speed compressor according to claim 4, wherein the variable speed mechanism further includes:
a control valve selective to apply the suction pressure or discharge pressure by a solenoid mechanism.

15. The variable speed compressor according to claim 1, further comprising:
an urging means for applying urging force to the first pressure sensing surface or second pressure sensing surface.

16. The variable speed compressor according to claim 15, wherein the urging means is a spring for urging the control ring in such a way that the compression mechanism is driven at a minimum speed.

17. The variable speed compressor according to claim 15, wherein the urging means is a spring for urging the control ring in such a way that the compression mechanism is driven at a maximum speed.

18. The variable speed compressor according to claim 1, wherein the control ring is movable based upon suction pressure by the compression mechanism.

19. The variable speed compressor according to claim 1, wherein the control ring is movable based upon external information detected by an electric control unit.

20. The variable speed compressor according to claim 1, wherein the first pressure sensing surface and the second pressure sensing surface are formed in annular end surfaces of the control ring for uniformly receiving pressure.

21. The variable speed compressor according to claim 1, wherein each planetary cone has a receiving surface for receiving torque of the input rotor, a control surface for varying speed of rotation of the planetary cone and an actuating surface for transmitting torque to the output rotor.

22. The variable speed compressor according to claim 1, wherein each planetary cone has a control and receiving surface for receiving torque of the input rotor and varying speed of rotation of the planetary cone, and an actuating surface for transmitting torque to the output rotor.

23. The variable speed compressor according to claim 1, further comprising:
a pressure regulator provided on one side of the output rotor for urging the output rotor toward the planetary cones.
